(19) United States
(12) Patent Application Publication
(10) Pub. No.: US 2011/0013258 A1
(43) Pub. Date: Jan. 20, 2011

(54) Manufacturing method of electronic paper display device and electronic paper display device manufactured therefrom

(75) Inventors: Hwan-Soo Lee, Seoul (KR); Yongsoo Oh, Seongnam-si (KR); Sang Moon Lee, Seoul (KR); Hye Yeon Cha, Yongin-si (KR); Jeong Bok Kwak, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 12/654,682

(22) Filed: Dec. 29, 2009

(30) Foreign Application Priority Data
Jul. 14, 2009 (KR) 10-2009-0064109
Aug. 6, 2009 (KR) 10-2009-0072392

(51) Int. Cl. G02F 1/167; H01J 9/20

(52) U.S. Cl. 359/296; 445/24

(57) ABSTRACT

The present invention relates to a manufacturing method of an electronic paper display device and an electronic paper display device manufactured therefrom.

The manufacturing method of the electronic paper display device may include forming a first auxiliary first dielectric layer on a first substrate; disposing electronic balls on the first auxiliary first dielectric layer; forming a second auxiliary first dielectric layer that fixes the electronic balls by curing the first auxiliary first dielectric layer; forming an auxiliary second dielectric layer on the second auxiliary first dielectric layer including the electronic balls; forming first and second dielectric layers by curing the second auxiliary first dielectric layer and the auxiliary second dielectric layer; and bonding the first substrate including the second dielectric layer to a second substrate.

### CROSS REFERENCES RELATED APPLICATIONS

The present application claims priority under 35 U.S.C. 119 and 35 U.S.C. 365 to Korean Patent Application No. 10-2009-0064109 filed on Jul. 14, 2009, which is hereby incorporated by reference in its entirety.

### BACKGROUND OF THE INVENTION

1. Field of the Invention

The present invention relates to an electronic paper display device and a manufacturing method thereof, and more particularly, to a manufacturing method of an electronic paper display device that fixes electronic balls onto an auxiliary dielectric layer and then forms another auxiliary dielectric layer on the auxiliary dielectric layer including the electronic balls, and an electronic paper display device manufactured therefrom.

2. Description of the Related Art

As a next generation display device, a liquid crystal display (LCD), a plasma display panel (PDP), an electroluminescence, an electronic paper display device, etc. have been widely spread.

Among others, the electronic paper display device is flexibly bendable and is much cheaper than other display devices in view of its production costs.

Further, the electronic paper display device does not need a background illumination or a continuous recharging so that it can be driven with very little energy, having significantly excellent characteristics in energy efficiency.

Moreover, the electronic paper display device is clear and has a wide viewing angle, and is also able to have a memory function that displayed characters or images do not completely disappear even though power is instantly blocked. Therefore, the electronic paper display device has been expected to be widely used in a foldable screen, an electronic wallpaper, etc. as well as print media such as books, newspapers or magazines.

Meanwhile, technical schemes capable of implementing the electronic paper display device have been largely divided into a scheme using a liquid crystal, an organic EL scheme, a reflection film reflective display scheme, an electrophoretic scheme, a twist ball scheme, an electrochromic scheme, a mechanical reflective display scheme, etc. and have been developed.

Among others, the electronic paper display device using the twist balls includes two electrodes and an elastomer sheet that is interposed between the two electrodes and to which the twist balls having an optical and electrical anisotropy are attached. At this time, dielectric liquid is coated on an outer circumferential surface of the twist ball. Herein, the twist ball may be configured of a black hemisphere and a white hemisphere that are charged with different charges. With the electronic paper display device using such twist balls, when voltage is applied to the two electrodes, the respective hemispheres of particles are rotated to face electrode surfaces of polarities opposite to each other inside the dielectric liquid according to the applied voltage direction, thereby displaying black and white.

At this time, it is difficult to uniformly dispose the twist balls and it is also difficult to constantly control the pitch between the twist balls, causing a problem that contrast ratio is degraded.

In order to solve this problem, there has been an attempt to improve the contrast ratio by disposing the twist balls to be overlapped to each other. However, when the twist balls are overlapped, problems arise in that the thickness of the electronic paper display device is increased as well as the driving voltage for driving the twist balls is raised.

Therefore, the electronic paper display device in the related art has a problem that the contrast ratio is degraded or the driving voltage is raised due to the degradation of uniformity in the arrangement of the twist balls.

### SUMMARY OF THE INVENTION

The present invention proposes to solve the problems that may occur in an electronic paper display device in the related art. It is an object of the present invention to provide a manufacturing method of an electronic paper display device that fixes electronic balls onto an auxiliary dielectric layer and then further forms another auxiliary dielectric layer on the auxiliary dielectric layer including the electronic balls, and an electronic paper display device manufactured therefrom.

The object of the present invention is to provide a manufacturing method of an electronic paper display device. The manufacturing method may include: forming a first auxiliary first dielectric layer on a first substrate; disposing electronic balls on the first auxiliary first dielectric layer; forming a second auxiliary first dielectric layer that fixes the electronic balls by curing the first auxiliary first dielectric layer; forming an auxiliary second dielectric layer on the second auxiliary first dielectric layer including the electronic balls; forming first and second dielectric layers by curing the second auxiliary first dielectric layer and the auxiliary second dielectric layer; and bonding the first substrate including the second dielectric layer to a second substrate.

Further, the forming the second auxiliary first dielectric layer may comprise semi-curing or completely curing the first auxiliary first dielectric layer.

Moreover, the electronic balls may be twist balls.

In addition, the manufacturing method of the electronic paper display device may further include, after the bonding the second substrate onto the second dielectric layer, dipping the first and second substrates into dielectric liquid.

Further, the electronic balls may be microcapsules.

Moreover, the first and second dielectric layers may be made of the same material.

In addition, the first and second dielectric layers may be made of different materials.

Further, the first dielectric layer may be formed of a light reflective layer and the second dielectric layer may be formed of a light transmission layer.

Moreover, the electronic balls may display any one of red, green and blue (RGB) and cyan, yellow and magenta (CYM).

It is another object of the present invention to provide an electronic paper display device. The electronic paper display device may include: a first dielectric layer that is disposed on a first substrate; electronic balls that are fixed onto the first dielectric layer; a second dielectric layer that forms a boundary with the first dielectric layer and is disposed on the first dielectric layer including the electronic balls; and a second substrate that is disposed on the second dielectric layer.

Further, the first and second dielectric layers may be made of different materials.

Moreover, the first dielectric layer may be formed of a light reflective layer and the second dielectric layer may be formed of a light transmission layer.

In addition, the first and second dielectric layers may be made of the same material.

Further, the electronic balls may be disposed in predetermined row and column.

Moreover, the electronic balls may be microcapsules.

In addition, the electronic balls may be twist balls.

Further, the electronic balls may display any one of red, green and blue (RGB) and cyan, yellow and magenta (CYM).

### BRIEF DESCRIPTION OF THE DRAWINGS

FIGS. 1 to 6 are cross-sectional views explaining a manufacturing method of an electronic paper display device according to a first embodiment of the present invention;

FIG. 7 is a plan view of a portion of an electronic paper display device according to a second embodiment of the present invention; and

FIG. 8 is a cross-sectional view taken along line I-I′ of FIG. 7.

FIG. 9 is a cross-sectional view of an electronic paper display device according to a third embodiment of the present invention.

### DESCRIPTION FOR KEY ELEMENTS IN THE DRAWINGS

110: First substrate
120a: First auxiliary first dielectric layer
120b: Second auxiliary second dielectric layer
120: First dielectric layer
130: Electronic ball
140a: Auxiliary second dielectric layer
140: Second dielectric layer

### DETAILED DESCRIPTION OF THE PREFERRED EMBODIMENTS

Hereinafter, exemplary embodiments of the present invention will be described in detail with reference to the accompanying drawings of an electronic paper display device. The exemplary embodiments of the present invention to be described below are provided so that those skilled in the art to which the present invention pertains can easily carry out the present invention. Therefore, the present invention may be modified in many different forms and it should not be limited to the embodiments set forth herein. In the drawings, the thickness and the size of the device may be exaggerated for the convenience. Like reference numerals designate like elements throughout the specification.

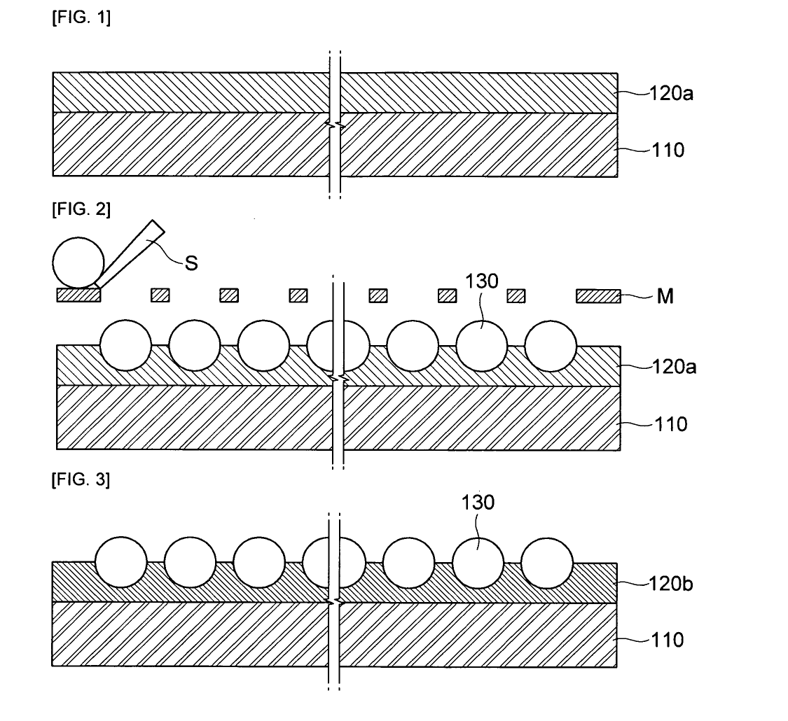

FIGS. 1 to 6 are cross-sectional views explaining a manufacturing method of an electronic paper display device according to a first embodiment of the present invention.

Referring to FIG. 1, in order to manufacture the electronic paper display device according to the embodiment of the present invention, a first auxiliary first dielectric layer 120a is first formed on a first substrate 110.

The first substrate 110 may be formed of a conductive substrate. Herein, the first substrate 110 may function as a supporting layer that supports the electronic paper display device as well as a first electrode.

Alternately, the first substrate 110 may include a first electrode that is formed of a conductive film and a first base layer disposed on a lower part of the first electrode. Herein, the first base layer may be formed in a substrate shape such as a plastic substrate, a glass substrate, etc., or may be formed in a film shape. The first base layer may be made of polyethylene terephthalate (PET), polyvinyl alcohol (PVA), polyethylene (PE), polycarbonate (PC), polyacrylate, polymethylmethacrylate, polyurethane, cellulose acetate buthylate (CAB), etc.

The conductive substrate or the conductive film may be made of metal such as Cu and Ag, but it not limited thereto in the embodiment of the present invention.

The first auxiliary first dielectric layer 120a may be formed by being coated with first dielectric material. Herein, the first auxiliary first dielectric layer 120a may be formed by selecting various materials, considering the characteristics of the electronic paper display device. For example, the first auxiliary first dielectric layer 120a may be a light transmission layer or a light reflective layer.

At this time, when the first auxiliary first dielectric layer 120a is a light transmission layer, the first dielectric material may be polyacryl-based resin, polyurethane acrylate (PUA)-based resin, polydimethylsiloxane (PDMS)-based resin, etc.

Alternately, when the first auxiliary first dielectric layer 120a is a light reflective layer, the first dielectric material may include resin and light reflective material mixed on the resin. At this time, the resin may be polyacryl-based resin, polyurethane acrylate (PUA)-based resin, polydimethylsiloxane (PDMS)-based resin, epoxy-based resin, polyimide-based resin, phenol-based resin, etc. by way of example. In addition, the light reflective material may be Ag powder by way of example.

A method of coating the first dielectric material may be a spin coating method, a doctor blade method, a die coating method, a screen printing method, a spray coating method, etc. by way of example.

Referring to FIG. 2, after forming the first auxiliary first dielectric layer 120a, electronic balls 130 are disposed on the first auxiliary first dielectric layer 120a.

Herein, in order to dispose the electronic balls 130, a mask M having opening portions is aligned on the first auxiliary first dielectric layer 120a. Thereafter, after providing the electronic balls 130 on the mask M, a squeeze S horizontally moves on the mask M so that the electronic balls 130 on the mask M can be selectively disposed on the first auxiliary first dielectric layer 120a through the opening portions. At this time, the electronic balls 130 may be disposed in a state that they are immersed into the first auxiliary first dielectric layer 120a. Therefore, the electronic balls 130 can be uniformly disposed on the first auxiliary first dielectric layer 120a.

In addition, the pitch between the electronic balls 130 may be controlled according to the shape of the mask M. Therefore, there is no need to overlappedly dispose the electronic balls 130 in order to prevent the contrast ratio of the electronic balls 130 from being degraded as in the related art, but even though the electronic balls 130 are disposed in a row, the contrast ratio thereof can be sufficiently prevented from being degraded by controlling the pitch between the electronic balls 130. In other words, the fill factor of the electronic balls 130 is enhanced by controlling the pitch between the electronic balls 130 to be almost 0, making it possible to improve the contrast ratio.

Therefore, compared to the related art, the electronic paper display device has the improved contrast ratio and enables to reduce the thickness of the electronic paper display device, and at the same time it also enables to reduce the driving voltage.

Further, the electronic balls may be disposed in various shapes according to the shape of the mask M. For example, when viewed from the plane, the electronic balls may be disposed in a rectangular shape, in a polygonal shape, and in a circular shape. Also, the electronic balls 130 may be disposed to have predetermined row and column. Therefore, the degree of freedom in designing the electronic paper display device can be improved simultaneously with improving the image quality characteristics.

Moreover, the electronic balls 130 can display an image according to the electric field applied to a first electrode and a second electrode. For example, the electronic ball 130 may be a twist ball configured of a first hemisphere that reflects light and a second hemisphere that absorbs light. In other words, the electronic ball 130 includes the first hemisphere displaying white and the second hemisphere displaying black so that the electronic paper display device can display black and white. Herein, the first hemisphere and the second hemisphere may be charged with different charges. Herein, the electronic balls 130 are rotated by the electric field formed by the electric field applied to the first and second electrodes, thereby making it possible to display an image.

Herein, the electronic balls 130 are explained to display black and white, but it is not limited thereto but is able to display color. At this time, the electronic balls 130 can display color, that is, red, green and blue (RGB) or cyan, yellow and magenta (CYM). For example, the first hemisphere of the electronic ball 130 can display white or black, and the second hemisphere thereof can display any one of red, green and blue (RGB) and cyan, yellow and magenta (CYM).

However, the sort of the electronic ball 130 is not limited in the present embodiment but, for example, the electronic ball 130 may be a microcapsule having particles charged with different charges therein.

Further, although the electronic ball 130 is illustrated to be immersed into the first auxiliary first dielectric layer 120a by its middle portion, it is not limited thereto but it is sufficient if the electronic ball 130 contacts the first auxiliary first dielectric layer 120a.

Referring to FIG. 3, after disposing the electronic balls 130 on the first auxiliary first dielectric layer 120a, the first auxiliary first dielectric layer 120a is semi-cured to form a second auxiliary first dielectric layer 120b. Thereby, the electronic balls 130 may be fixed by the second auxiliary first dielectric layer 120b in a semi-cured state.

Therefore, the electronic balls 130 disposed on the first auxiliary first dielectric layer 120a are fixed by the mask (M in FIG. 2), making it possible to maintain the arrangement state of the electronic balls up to a subsequent process.

In the embodiment of the present invention, the second auxiliary first dielectric layer 120b in the semi-cured state is described to be formed to fix the electronic balls 130, but it is not limited thereto. For example, the first dielectric layer 120 is formed by completely curing the first auxiliary first dielectric layer 120a, making it possible to proceed with a subsequent process in a state where the electronic balls 130 are fixed to the first dielectric layer 120.

Referring to FIG. 4, after fixing the electronic balls 130 to the second auxiliary first dielectric layer 120b, an auxiliary second dielectric layer 140a is formed on the second auxiliary first dielectric layer 120b including the electronic balls 130. The auxiliary second dielectric layer 140a may be formed to completely cover the electronic balls 130 exposed from the second auxiliary first dielectric layer 120b.

Herein, the auxiliary second dielectric layer 140a may be formed by being coated with second dielectric material. At this time, the auxiliary second dielectric layer 140a may be formed of a light transmission layer that can transmit light. The second dielectric material may be polyacryl-based resin, polyurethane acrylate (PUA)-based resin, polydimethylsiloxane (PDMS)-based resin, etc. At this time, the auxiliary second dielectric layer 140a may be made of the same material as the first auxiliary first dielectric layer 120a.

A method of coating the first dielectric material may be a spin coating method, a doctor blade method, a die coating method, a screen printing method, a spray coating method, etc. by way of example.

Referring to FIG. 5, after forming the auxiliary second dielectric layer 140a, the second auxiliary first dielectric layer 120b and the auxiliary second dielectric layer 140a are completely cured to form first and second dielectric layers 120 and 140.

At this time, the first and second dielectric layers 120 and 140 each may have a predetermined boundary surface. This is the reason that the first dielectric layer 120 and the second dielectric layer 140 are formed by simultaneously curing the semi-cured second auxiliary first dielectric layer 120b and the non-cured auxiliary second dielectric layer 140a completely. In other words, since the first and second dielectric layers 120 and 140 each have different start cured state, the first and second dielectric layers 120 and 140 each have a predetermined boundary surface and have different degree of cure.

Referring to FIG. 6, after forming the first and second dielectric layers 120 and 140, a second substrate 150 is bonded onto the second dielectric layer 140.

The second substrate 150 functions as a second electrode, wherein it may be a transparent conductive substrate that can transmit light. Alternately, the second substrate 150 may include a second electrode made of a transparent conductive film and a second base layer disposed on the second electrode.

The second base layer may be formed in a substrate shape such as a plastic substrate, a glass substrate, etc., or may be formed in a film shape. The second base layer may be made of polyethylene terephthalate (PET), polyvinyl alcohol (PVA), polyethylene (PE), polycarbonate (PC), polyacrylate, polymethylmethacrylate, polyurethane, cellulose acetate buthylate (CAB), etc.

Further, the transparent conductive substrate or the conductive film may be made of ITO, IZO, ITZO, etc. by way of example.

Although not shown in the drawing, the first and second substrates 110 and 150 may be bonded to each other using a transparent adhesive member coated on the second dielectric layer 140, for example, silicon-based resin.

In addition, when the electronic balls 130 are twist balls, the bonded first and second substrates 110 and 150 are dipped into dielectric liquid. Thereby, the dielectric layer may be disposed around the electronic balls through porous provided on the first and second dielectric layers 120 and 140. In other words, the electronic balls may be disposed inside the first and second dielectric layers 120 and 140, while being floated on the dielectric liquid.

In the embodiment of the present invention, the electronic ball 130 is formed in a single layer, but it is not limited thereto. For example, the electronic ball 130 may be formed in a two-layer or in a multi-layer of two layers or more by repeating the processes of disposing the first dielectric layer and the electronic balls and forming the second dielectric layer once or twice or more.

Therefore, in the embodiment of the present invention, after disposing the electronic balls with a predetermined arrangement on the non-cured auxiliary dielectric layer using the mask, the non-cured dielectric layer is semi-cured or cured to fix the electronic balls, making it possible to control the disposition degree of the electronic balls.

Therefore, since the electronic balls can be arranged to regularly have a predetermined pitch, they are not required to be overlappedly formed as in the related art, making it possible to arrange the electronic balls in a row. Therefore, the electronic paper display device can improve the contrast ratio simultaneously with reducing the thickness compared to the related art, making it possible to lower the driving voltage of the electronic paper display device.

Further, the electronic balls can be arranged in various shapes according to the arrangement shape of the mask, making it possible to enhance the degree of freedom in designing the electronic paper display device.

Moreover, the first and second dielectric layers are formed through different processes, making it possible to freely select the material of the first dielectric layer in order to improve the characteristics of the electronic paper display device.

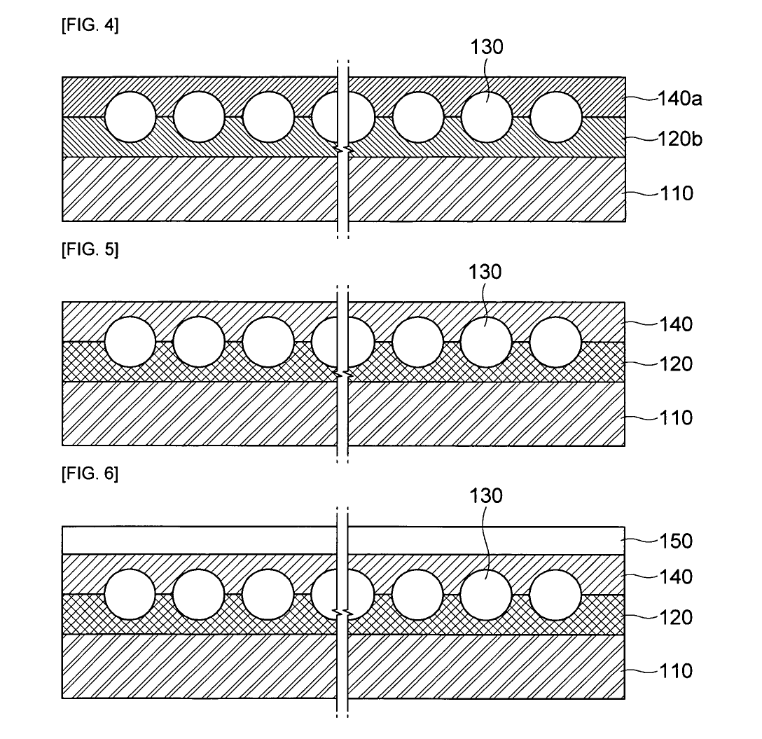

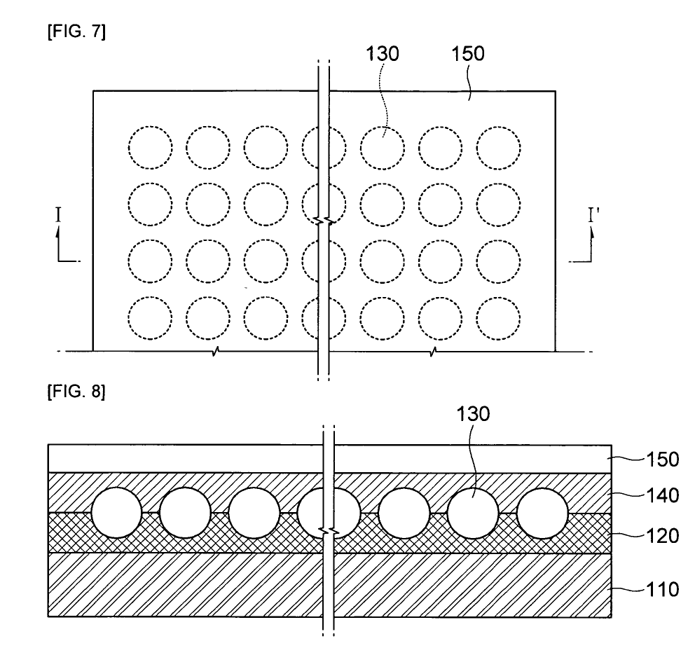

Hereinafter, the electronic paper display device manufactured according to the first embodiment of the present invention will be described in detail with reference to FIGS. 7 and 8.

FIG. 7 is a plan view of a portion of an electronic paper display device according to a second embodiment of the present invention.

FIG. 8 is a cross-sectional view taken along line I-I′ of FIG. 7.

Referring to FIGS. 7 and 8, the electronic paper display device according to the embodiment of the present invention may include first and second substrates 110 and 150 that face each other, a first dielectric layer 120 disposed on the first substrate 110, electronic balls 130 whose portions are immersed into the first dielectric layer 120, and a second dielectric layer 140 forming a boundary with the first dielectric layer 120 and disposed on the first dielectric layer 120 including the electronic balls 130.

The first substrate 110 may include a conductive substrate or a conductive film and a first base layer disposed on the conductive film. Herein, the conductive substrate and the conductive film may function as a first electrode. At this time, the conductive substrate may function as a supporting layer that supports the electronic paper display device simultaneously with functioning as the first electrode.

Further, the conductive substrate and the conductive film are reflective electrodes, wherein the conductive substrate and the conductive film may be made of metal such as Cu and Ag by way of example.

The first dielectric layer 120 is formed through a separate process from the second dielectric layer 140 to be described later so that it may freely select the material separately from the second dielectric layer 140 in order to improve the characteristics of the electronic paper display device. For example, the first dielectric layer 120 may be made of the same material as the second dielectric layer 140. The first dielectric layer 120 may be a light transmission layer. At this time, the first dielectric layer may be made of polyacryl-based resin, polyurethane acrylate (PUA)-based resin, polydimethylsiloxane (PDMS)-based resin, etc. Alternately, the first dielectric layer 120 may be made of material different from the second dielectric layer 140. The first dielectric layer 120 may be a light reflective layer. At this time, the first dielectric layer 120 may include resin and light reflective material mixed on the resin. Herein, the resin may be polyacryl-based resin, polyurethane acrylate (PUA)-based resin, polydimethylsiloxane (PDMS)-based resin, epoxy-based resin, polyimide-based resin, phenol-based resin, etc. by way of example. Also, the light reflective material may be Ag powder by way of example. Therefore, when the first dielectric layer 120 is formed of the light reflective layer, the first dielectric layer upward reflects light leaked downward, thereby serving to improve the light efficiency of the electronic paper display device.

The electronic balls 130 may be disposed in a state where portions thereof are immersed into the first dielectric layer 120. At this time, the electronic balls 130 are disposed in predetermined row and column, making it possible to improve the image quality characteristics of the electronic paper display device. Also, in view of the cross-sections of the electronic balls 130, the electronic balls 130 may be disposed to have a predetermined pitch in a row, such that the electronic paper display device can improve the contrast ratio simultaneously with reducing the thickness thereof compared to the related art, making it possible to lower the driving voltage thereof. This is the reason that in order to dispose the electronic balls 130, the electronic balls 130 with a predetermined arrangement are disposed on a non-cured auxiliary dielectric layer using the mask and then the electronic balls are fixed by semi-curing or curing the non-cured auxiliary dielectric layer, making it possible to control the disposition of the electronic balls 130.

Further, the electronic balls 130 may be uniformly disposed in various spaces, for example, in a rectangular shaped space, in a polygonal shaped space, and in a circular shaped space. This is the reason that the arrangement shape of the electronic balls can be variously changed according to the shape of the mask used in forming the electronic paper display device.

In the embodiment of the present invention, although the electronic ball 130 is illustrated to be immersed into the first dielectric layer 120 by its middle portion, it is not limited thereto but only the portion of the electronic ball 130 may contact the first auxiliary first dielectric layer 120a to the extent that it is fixed to the first dielectric layer 120 or may be immersed into the first dielectric layer 120 by its middle portion or more.

The electronic balls 130 may be twist balls or microcapsules that are flowed by voltage applied to each of first and second electrodes to display an image. At this time, when the electronic balls 130 are twist balls, dielectric liquid may be disposed around the twist balls. In other words, the electronic balls 130 may be disposed in a state where they are floated on the dielectric liquid.

The second dielectric layer 140 may be a light transmission layer. Herein, the second dielectric layer 140 may be made of the same material as the first dielectric layer 120. At this time, the second dielectric layer 140 may be made of polyacryl-based resin, polyurethane acrylate (PUA)-based resin, polydimethylsiloxane (PDMS)-based resin, etc.

The second dielectric layer 140 can cover the electronic balls immersed into the first dielectric layer 120. At this time, the first and second dielectric layers 120 and 140 have each different start cured state, for example, the first dielectric layer 120 being an auxiliary dielectric layer in a semi-cured state or in a completely cured state and the second dielectric layer 140 being formed by simultaneously curing the auxiliary dielectric layer in a non-cured state, such that the first and second dielectric layers 120 and 140 may have different degrees of cure. Also, the first and second dielectric layers 120 and 140 may be stacked with each other, having a predetermined boundary therebetween.

The second substrate 150 may include a transparent conductive substrate or a transparent conductive film, that can transmit light, and a second base layer disposed on the conductive film. Herein, the transparent conductive substrate and the conductive film may function as a second electrode. Also, the second base layer may be formed in a substrate shape such as a plastic substrate, a glass substrate, etc., or may be formed in a film shape. The second base layer may be made of polyethylene terephthalate (PET), polyvinyl alcohol (PVA), polyethylene (PE), polycarbonate (PC), polyacrylate, polymethylmethacrylate, polyurethane, cellulose acetate buthylate (CAB), etc.

Further, the transparent conductive substrate or the conductive film may be made of ITO, IZO, ITZO, etc. by way of example.

In addition, a transparent adhesive member, for example, silicon-based resin, is interposed between the second dielectric layer 140 and the second substrate 150, such that the second substrate 150 may be bonded onto the second dielectric layer 140.

Therefore, the electronic paper display device according to the embodiment of the present invention is manufactured according to the processes to selectively dispose and fix the electronic balls onto the auxiliary dielectric layer using the mask and then, to manufacture another auxiliary dielectric layer on the auxiliary dielectric layer including the electronic balls, such that the electronic paper display device can improve the contrast ratio simultaneously with reducing the thickness thereof compared to the related art, making it possible to lower the driving voltage of the electronic paper display device.

Further, the electronic balls can be arranged in various shapes according to the arrangement shape of the mask, making it possible to enhance the degree of freedom in designing the electronic paper display device.

Moreover, the first and second dielectric layers are formed through different processes, making it possible to freely select the material of the first dielectric layer in order to improve the characteristics of the electronic paper display device.

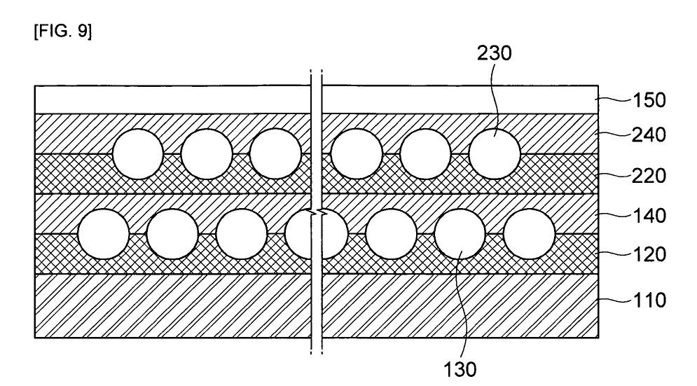

Hereinafter, another shape of the electronic paper display device that can be manufactured according to the first embodiment of the present invention will be described with reference to FIG. 9. The third embodiment of the present invention may have the same constitution as the aforementioned second embodiment, excepting for the feature that the electronic ball is formed in a two-layer. Therefore, for the convenience of explanation, the same reference numerals will be given to the same constituents and the overlapped explanation thereof will be omitted.

FIG. 9 is a cross-sectional view of an electronic paper display device according to a third embodiment of the present invention.

Referring to FIG. 9, the electronic paper display device according to the third embodiment may include first and second substrates 110 and 150 that face each other, a first dielectric layer 120 disposed on the first substrate 110, electronic balls 130 whose portions are immersed into the dielectric layer 120, and a second dielectric layer 140 forming a boundary with the first dielectric layer 120 and disposed on the first dielectric layer 120 including the electronic balls 130.

The electronic paper display device may further include an additional first dielectric layer 220 disposed on the second dielectric layer 140, additional electronic balls 230 whose portions are immersed into the additional first dielectric layer 220, and an additional second dielectric layer 240 disposed on the additional first dielectric layer 220 including the additional electronic balls 230. At this time, the additional electronic balls 230 may be disposed between the neighboring electronic balls 130. In other words, the portions of the additional electronic balls 230 may be disposed overlappedly with the electronic balls 130. Thereby, the electronic paper display device can prevent the brightness from being degraded as the non-display area is generated among the display area due to the intervals between the electronic balls 130.

The additional first and second dielectric layers 220 and 240 may be made of the same material or different materials. Herein, the additional first and second dielectric layers 220 and 240 may be made of the same material as the first dielectric layer 120 or the second dielectric layer 140. At this time, the additional first and second dielectric layers 220 and 240 may be made of light transmission material.

Herein, the additional first dielectric layer, the disposition of the additional electronic balls, and the second dielectric layer may be formed using the processes of forming the first dielectric layer, disposing the electronic balls and forming the second dielectric layer.

In the embodiment of the present invention, although the electronic paper display device describes that the additional electronic balls 230 and the additional first and second dielectric layers 220 and 240 are formed in a single layer, they are not limited thereto but they may be formed in two layers or more.

Therefore, the electronic paper display device can have the electronic balls formed in a two-layer or in a multi-layer of two layers or more as well as the electronic balls formed in a single layer as shown in the embodiment of the present invention.

The electronic paper display device according to the present invention can dispose the electronic balls in predetermined row and column, having a predetermined pitch, to enable to reduce the thickness of the electronic paper display device simultaneously with improving the image quality characteristics and the contrast ratio, making it possible to lower the driving voltage.

In addition, the electronic balls can be arranged in various shapes, making it possible to enhance the degree of freedom in designing the electronic paper display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A manufacturing method of an electronic paper display device, comprising:
forming a first auxiliary first dielectric layer on a first substrate;
disposing electronic balls on the first auxiliary first dielectric layer;
forming a second auxiliary first dielectric layer that fixes the electronic balls by curing the first auxiliary first dielectric layer;
forming an auxiliary second dielectric layer on the second auxiliary first dielectric layer including the electronic balls;
forming first and second dielectric layers by curing the second auxiliary first dielectric layer and the auxiliary second dielectric layer; and
bonding the first substrate including the second dielectric layer to a second substrate.

2. The manufacturing method of the electronic paper display device according to claim 1, wherein the forming the second auxiliary first dielectric layer comprises semi-curing or completely curing the first auxiliary first dielectric layer.

3. The manufacturing method of the electronic paper display device according to claim 1, wherein the electronic balls are twist balls.

4. The manufacturing method of the electronic paper display device according to claim 3, further comprising, after the bonding the second substrate onto the second dielectric layer: dipping the first and second substrates into dielectric liquid.

5. The manufacturing method of the electronic paper display device according to claim 1, wherein the electronic balls are microcapsules.

6. The manufacturing method of the electronic paper display device according to claim 1, wherein the first and second dielectric layers are made of the same material.

7. The manufacturing method of the electronic paper display device according to claim 1, wherein the first and second dielectric layers are made of different materials.

8. The manufacturing method of the electronic paper display device according to claim 7, wherein the first dielectric layer is formed of a light reflective layer and the second dielectric layer is formed of a light transmission layer.

9. The manufacturing method of the electronic paper display device according to claim 1, wherein the electronic ball includes a hemisphere that displays any one of red, green and blue (RGB) and cyan, yellow and magenta (CYM).

10. An electronic paper display device, comprising:
a first dielectric layer that is disposed on a first substrate;
electronic balls that are fixed onto the first dielectric layer;
a second dielectric layer that forms a boundary with the first dielectric layer and is disposed on the first dielectric layer including the electronic balls; and
a second substrate that is disposed on the second dielectric layer.

11. The electronic paper display device according to claim 10, wherein the first and second dielectric layers are made of different materials.

12. The electronic paper display device according to claim 11, wherein the first dielectric layer is formed of a light reflective layer and the second dielectric layer is formed of a light transmission layer.

13. The electronic paper display device according to claim 10, wherein the first and second dielectric layers are made of the same material.

14. The electronic paper display device according to claim 10, wherein the electronic balls are disposed in predetermined row and column.

15. The electronic paper display device according to claim 10, wherein the electronic balls are microcapsules.

16. The electronic paper display device according to claim 10, wherein the electronic balls are twist balls.

17. The electronic paper display device according to claim 10, wherein the electronic ball includes a hemisphere that displays any one of red, green and blue (RGB) and cyan, yellow and magenta (CYM).
